(19) United States
(12) Patent Application Publication
(10) Pub. No.: US 2008/0199117 A1
(43) Pub. Date: Aug. 21, 2008

(54) Load Sensing Bearing

(75) Inventor: Mark A. Joki, Dover, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, CANTON, OH (US)

(21) Appl. No.: 11/912,274

(22) PCT Filed: Apr. 27, 2006
(86) PCT No.: PCT/US2006/016018

§ 371 Date: Oct. 22, 2007

Related U.S. Application Data
(60) Provisional application No. 60/676,414, filed on Apr. 29, 2005.

(51) Int. Cl. F16C 32/04

(52) U.S. Cl. 384/448

(57) ABSTRACT

A roller bearing assembly (100), such as for use in supporting a vehicle wheel assembly, incorporates a set of rollers (104) disposed between an outer supporting race (102) and an inner supporting race (106). The set of rollers (104) is maintained between the outer and inner supporting races (102, 106) by an annular rib ring (108), which is configured to transfer forces and loads received from the rollers (104) to one or more sensors (110A) disposed between the annular rib ring (108) and an annular outer shell (114) encapsulating the roller bearing assembly (100). Responsive output signals from the sensors (110A), which are representative of the forces and loads exerted by the rollers (104), are communicated to an external system to provide a representation of the roller bearing assembly (100) operating condition.

### CROSS-REFERENCE TO RELATED APPLICATIONS

The present application is related to, and claims priority from, U.S. Provisional Patent Application No. 60/676,414 filed on Apr. 29, 2005, and which is herein incorporated by reference.

### BACKGROUND ART

The present invention relates generally to sensors for measuring bearing load forces, and in particular, to a bearing load sensor configuration which is suitable for use in vehicle wheel bearing applications.

The ability to measure live vehicle wheel forces and loads enhances the ability to manage vehicle brake and drive systems, particularly to counteract undesirable vehicle responses in a wide range of driving situations. For example, a yaw sensor associated with vehicle may be used to compare the actual rate of turn experienced by a vehicle with the driver's steering input. If the measured rate of turn does not correspond to the driver's steering input, a vehicle stability or control system may be activated to selectively redirect torque to different vehicle wheels, or to selectively apply a braking force to individual vehicle wheel in an attempt to achieve the desired vehicle turn.

Measurements of forces and loads specific to individual vehicle wheels, such as instantaneous frictional coefficients and sliding velocities may provide use useful information to vehicle control systems. However, systems which are capable of providing measurements of instantaneous frictional coefficients and sliding velocities at the individual wheels of a vehicle are generally prohibitively expensive for inclusion in most vehicle applications.

Accordingly, it would be advantageous to provide an integrated component in a vehicle wheel assembly, such as a bearing, with suitable sensors capable of measuring forces and loads on the vehicle wheel assembly, such as measurements of instantaneous frictional coefficients and sliding velocities. It would be further advantageous if the integrated component, configured with the sensors, was suitable for cost effective mass production to enable the integrated component to be readily incorporated into a wide range of vehicle applications.

### SUMMARY OF THE INVENTION

Briefly stated, the present invention provides a roller bearing assembly, such as for use in supporting a vehicle wheel assembly, which incorporates a set of rollers disposed between inner and outer supporting races. The set of rollers are maintained between the inner and outer supporting races by an annular rib ring, which is configured to transfer forces and loads received from the rollers to one or more sensors disposed between the annular rib ring and an annular outer shell encapsulating the roller bearing assembly. Responsive output signals from the sensors are representative of the forces and loads exerted by the rollers, and may be communicated to an external system to provide a representation of the roller bearing assembly operating condition.

In an alternate embodiment of the present invention, the sensors are compressive load sensors, and are equidistantly disposed in an annular arrangement. Each compressive load sensor is positioned in contact with an associated protrusion on the rib ring, such that loads and forces exerted on the rib ring by the set of rollers are directly transferred to the compressive load sensors.

In an alternate embodiment of the present invention, the sensors are strain gauges, and are equidistantly disposed in an annular arrangement about a flexible support element retained between the rib ring and outer shell. The flexible element is supported against axial movement at a plurality of raised points on the outer shell, which are offset from a second plurality of raised points on the rib ring which contact the opposite surface of the flexible element. Loads and forces transmitted from the set of rolling elements to the rib ring are in turn, transmitted through the plurality of raised contact points into the flexible element, and eventually to the outer shell. Loads and forces exerted on the flexible element by the raised points generate responsive strain forces in the flexible element which are registered by the strain gauges. Responsive output signals from the strain gauges are representative of the forces and loads exerted by the rollers, and may be communicated to an external system to provide a representation of the roller bearing assembly operating condition.

In a variation of the present invention, the sensors are pressure sensors, and are equidistantly disposed in an annular arrangement within an annular region between the rib ring and outer shell which is filled with a relatively incompressible material. Loads and forces transmitted from the set of rolling elements to the rib ring are in turn, transmitted through the relatively incompressible material, and eventually to the outer shell. Loads and forces exerted on the relatively incompressible are registered by the pressure sensors. Responsive output signals from the pressure sensors are representative of the forces and loads exerted by the rollers, and may be communicated to an external system to provide a representation of the roller bearing assembly operating condition.

The foregoing features, and advantages of the invention as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1 is a partial sectional view of a roller bearing assembly of the present invention configured with compression sensors;

FIG. 2 is a perspective view of an annular circuit board of the present invention, having equidistantly spaced gaps over which load sensors are secured;

FIG. 3 is a partial sectional view of an alternate roller bearing assembly of the present invention configured with strain sensors;

FIG. 4 is a simplified exploded perspective view of the rib ring, flexible element, and outer shell of the embodiment shown in FIG. 3, illustrating load and force transfers there between;

FIG. 5 is a perspective illustration of a flexible element of FIG. 3, illustrating placement of the strain sensors and flexible circuit; and

FIG. 6 is a partial sectional view of an alternate roller bearing assembly of the present invention configured with pressure sensors.

Corresponding reference numerals indicate corresponding parts throughout the several figures of the drawings. It is to be understood that the drawings are for illustrating the concepts of the invention and are not to scale.

### DESCRIPTION OF THE PREFERRED EMBODIMENT

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

Referring to FIG. 1, a roller bearing assembly 100 for supporting a vehicle wheel assembly 10 comprises at least one non-rotating outer race 102, with at least one set of rollers 104, acting against a corresponding inner race 106 that rotates with the wheel assembly 10. A rib ring 108 is provided at each end of the outer race 102 to resist the tendency of the rollers 104 to move axially outwardly from their normal position between the outer race 102 and the inner race 106. The rib ring 108 is axially restrained by at least three equidistantly spaced compressive load sensors 110 which are mounted to an annular circuit board 112 abutted to an outer shell 114, which in turn, is fixed to the outer race 102. The outer shell 114 additionally supports a lip-type seal 116 to prevent a loss of lubrication and any intrusion of contaminants to the bearing surfaces. Preferably, the outer shell 114 is rolled over a groove 115 in the outer race 102 to facilitate low cost manufacturing and assembly.

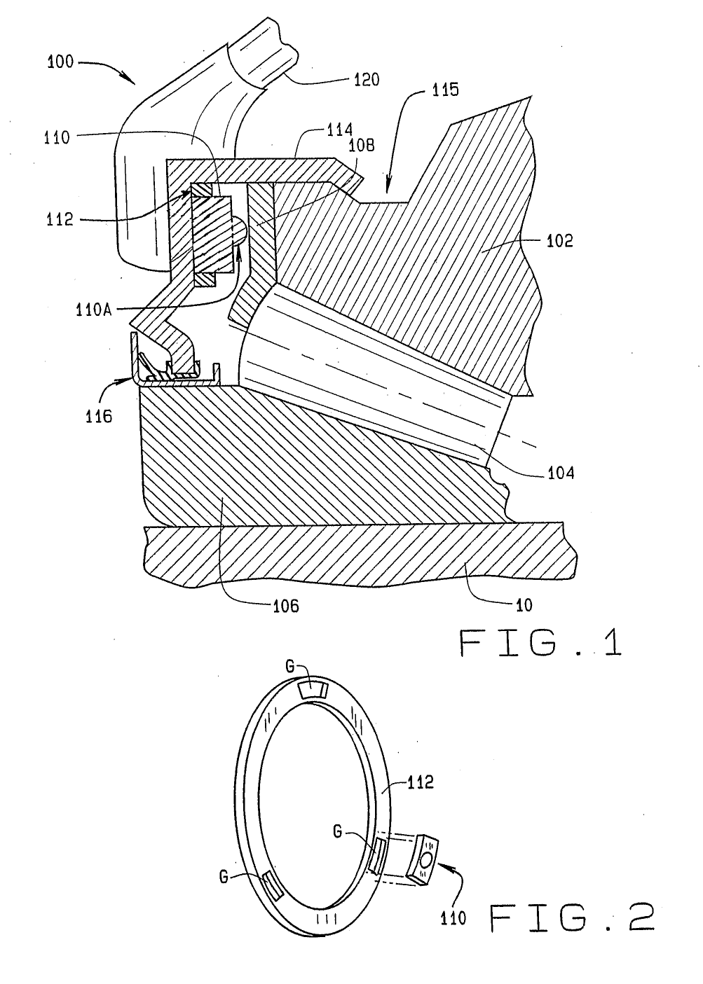

Each of the three compressive load sensors 110 is preferably a surface mounted integrated circuit (IC), which extends through a hole or gap G in the annular circuit board 112, as shown in FIGS. 1 and 2. The rib ring 108 applies a compressive force to a raised portion 110A of each load sensor 110, which is axially unsupported by the circuit board 112 due to the presence of the hole or gap G, causing a localized stress within the load sensor 110, and a corresponding change in resistance of the load sensor 110. The circuit board 112 itself is not stressed by the applied loads, which are applied only to the load sensor 110 and to associated the integrated circuit (IC). The output of the load sensor 110 is proportional to the stress on the load sensor 110, providing a measurement which is representative of the applied load from the rib ring 108. Output signals from each load sensor 110 are communicated via a connecting cable 120 to a vehicle control system (not shown), where they are processed and utilized to determine a force or load acting on the vehicle wheel assembly 10 supported by the bearing assembly 100. Those of ordinary skill in the art will recognize that the load sensors 110 may be secured within the bearing assembly 100 to receive tension loads as well as compressive loads, and to provide corresponding output signals.

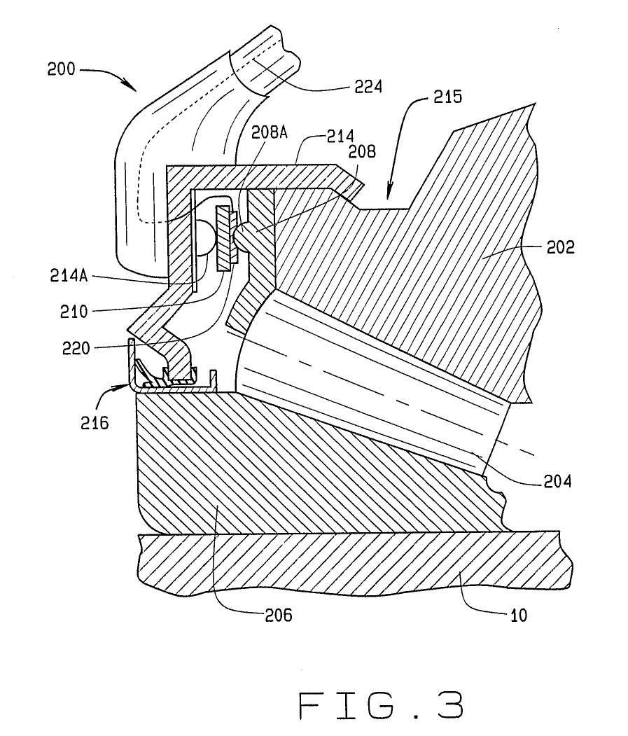

Turning to FIG. 3 through FIG. 5, an alternate embodiment of the roller bearing assembly of the present invention is shown generally at 200 for supporting a vehicle wheel assembly 10. The roller bearing assembly 200 comprises a non-rotating outer race 202, with at least one set of rollers 204, such as tapered rollers, acting against a corresponding inner race 206 that rotates with the wheel assembly 10. A rib ring 208 is provided at each end of the outer race 202 to resist the tendency of the rollers 204 to move axially outwardly from their normal position between the outer race 202 and the inner race 206. The rib ring 208 is axially restrained by an annular flexing element 210, such as a spring disc, which receives a load or force from the rib ring 208 at three equidistantly spaced protrusions 208A disposed on the rib ring 208. The loads or forces received at the flexing element 210 are in turn, transferred to another element of the bearing assembly 200, such as the outer shell 214, at three equidistantly spaced protrusions 214A, which are circumferentially offset from the three equidistantly spaced protrusions 208A on the rib ring 208. The outer shell 214 fixed to the outer race 202 and supports a lip-type seal 216 to prevent a loss of lubrication and any intrusion of contaminants to the bearing surfaces. The outer shell 214 may be rolled over a groove 215 in the outer race 202 to facilitate low cost manufacturing and assembly.

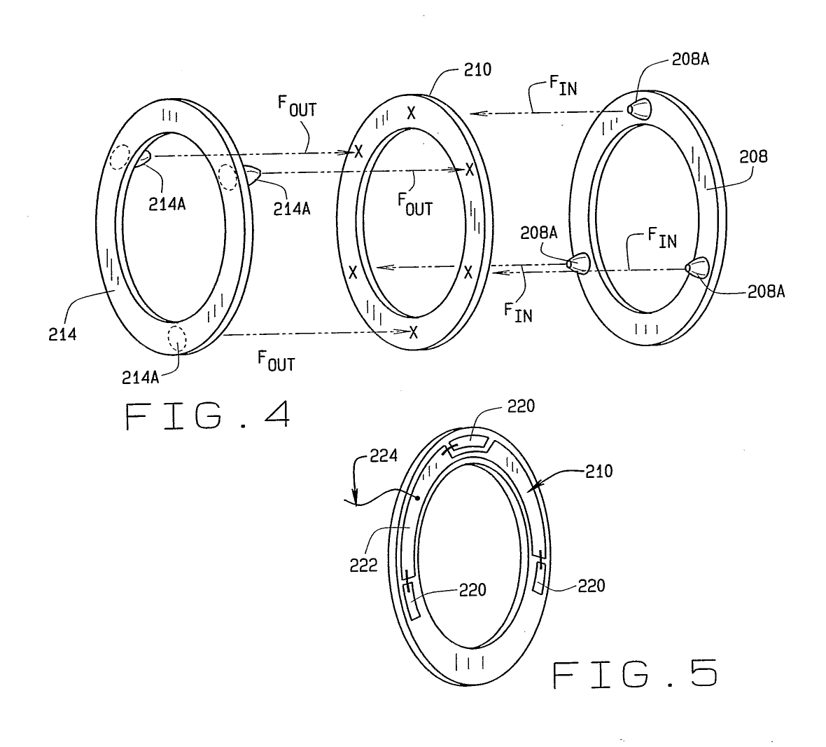

As best seen in FIG. 4, loads or forces Fin transferred from the protrusions 208A into the flexing element 210 are supported by counteracting loads or forces Fout at the offset protrusions 214A, such that the flexing element 210 is axially deflected at multiple points in response to the applied loads or forces. Preferably, the flexing element 210 is mounted with a limited clearance for movement, so that the flexing element 210 is not damaged by overload forces. To measure the axial deflection, the flexing element 210 is fitted with a set of circumferentially oriented strain gauges 220, as shown in FIG. 5, to measure the bending strains in the flexing element 210. A flexible circuit 222 is laid over the strain gauges 220 and operatively coupled thereto, such as by soldering to contact pads of the strain gauges 220. The flexible circuit 222 contains suitable integrated circuits to provide electrical power the individual strain gauges 220, to adjust the strain gauge output signals for temperature, and to translate the strain gauge output signals to a noise-immune analog current or digital signal, which is subsequently routed to the vehicle control system (not shown) via the interconnecting wiring 222. Those of ordinary skill in the art will recognize that the flexing element 210 may be secured within the bearing assembly 200 to receive tension loads as well as compressive loads, and to provide corresponding output signals.

Prior to use it is necessary to calibrate the sensors 110 and 220. The sensors 110 and 220 may be calibrated by discretely placing a known axial load or force directly at the locations of the individual sensors 110, 220. Each sensor will generate a response signal to the applied loads or forces. For example, for a known applied load at a first sensor 110, 220, designated sensor A, a direct sensitivity factor is defined as the known load divided by the sensor A response, while the cross sensitivity factors of the second and third sensors (designated sensor B and sensor C) will be the known load divided by the corresponding sensor response. During a calibration procedure, a response is observed at each sensor. The actual load at each sensor is defined as the corresponding sensor response multiplied by the direct sensitivity factor, minus the sensor response at each of the other sensors multiplied by the associated cross sensitivity factors. The actual loads of the three sensors are then summed and ranked for magnitude. The ratio (MX_{RATIO}) of the maximum sensor load to the sum of the sensor loads is calculated, as is the ratio (SIDE_{RATIO}) of the second highest sensor load to that of the lowest sensor load. The parameters MX_{RATIO} and SIDE_{RATIO} identify: (1) the ratio of the sensor force sum to the radial load; (2) the ratio of the sensor force sum to the axial load; and (3) the rotational angle from the sensor with the maximum load to the radial load vector. These relationships can be empirically determined by applying combinations of axial and radial loads and saving the observed ratios in a look-up table, or they can be analytically determined such as by using known relationships.

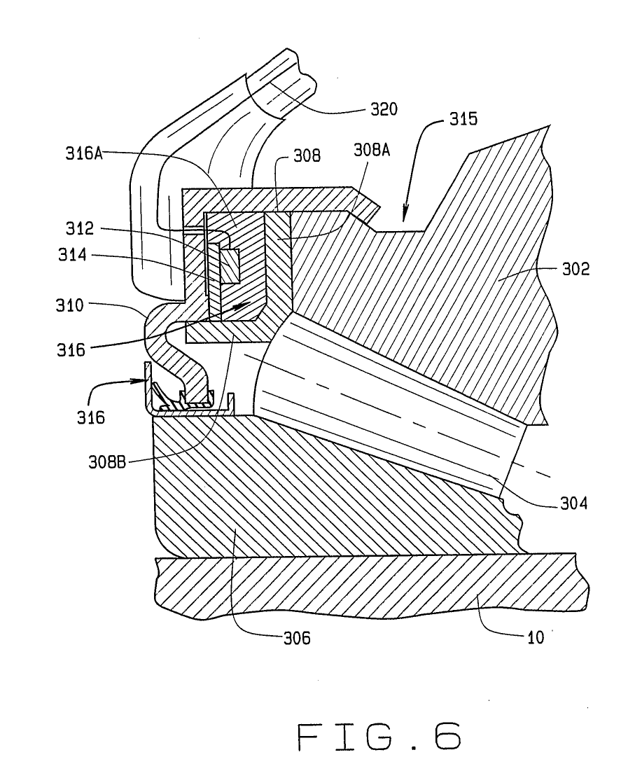

Sensors other than compressive load sensors 110 and strain gauges 220 may be utilized to acquire measurements of the forces and loads at a vehicle wheel assembly 10. For example in FIG. 6, a third alternate embodiment of the of the roller bearing assembly of the present invention is shown generally at 300 for supporting a vehicle wheel assembly 10. The roller bearing assembly 300 comprises a non-rotating outer race 302, with at least one set of rollers 304, such as tapered rollers, acting against a corresponding inner race 306 that rotates with the wheel assembly 10. A rib ring 308 is provided at each end of the outer race 302 to resist the tendency of the rollers 304 to move axially outwardly from their normal position between the outer race 302 and the inner race 306. The rib ring 308 includes both a disk section 308A, and a cylindrical section 308B. The rib ring forms a first seal to the outer shell 310 at the outer periphery of the disk section 308A, and a second seal to the outer shell 310 at the outer circumference of the cylindrical section 308B, while providing clearance for a small amount of axial movement of the rib ring 308.

Measurements of the loads or forces exerted on the roller bearing assembly 300 by the wheel assembly 10 are acquired by at least three pressure sensors 312 secured to an annular circuit board 314 disposed in the annular cavity 316 between the rib ring 308 and the outer shell 310. The cavity 316 is filled with an essentially incompressible material 316A which resists circumferential flow, such as a room temperature vulcanizing (RTV) type of material. Loads or forces from the rolling elements 304 are transferred to the rib ring 308, and through the material 316A to the pressure sensors 312, which provide proportional output signals representative of a load distribution on the rib ring 308. While a minimum of three pressure sensors 312 may be utilized with the roller bearing assembly 300, when load zones within the cavity 316 have an arcuate range of less than approximately 270 degrees, it will be necessary to dispose a pressure sensor 312 near the point of maximum load to avoid negative loads at some of the remaining pressure sensors, due to a tendency of the rib ring 308 to tilt in response to the non-uniform load.

Integrated circuits (not shown) disposed on the annular circuit board 314 provide electrical power the individual pressure sensors 312 and translate the pressure sensor output signals to noise-immune analog currents or digital signals, which are subsequently routed to the vehicle control system (not shown) via the interconnecting wiring 320.

As various changes could be made in the above constructions without departing from the scope of the invention, it is intended that all matter contained in the above description or shown in the accompanying drawings shall be interpreted as illustrative and not in a limiting sense.

1. A roller bearing assembly, comprising:
an annular outer race surrounding an annular inner race;
a set of rollers being contained in a radial gap between said inner and outer races; said tapered rollers transmitting both axial and radial loads between said inner race and said outer race;
a rib ring contacting an outer end of said rollers to contain the rollers, and an annular sensing device proximate a surface of said rib ring opposite said rollers; said sensing device having at least three spaced apart sensing locations; at least a portion of said axial and radial loads being transmitted to said rib ring; said rib ring transmitting said radial and axial loads from said rollers to said sensing device, said sensing device generating an output representative of the axial and radial loads applied to the roller bearing assembly.

2. The roller bearing assembly according to claim 1 said sensing device including a sensor at each of said sensing locations, said output of said sensors being calibrated individually to a known load at each of said three annularly dispersed positions; and
wherein a ratio of maximum sensor load to a sum of said sensor loads, and a ratio of an intermediate sensor load to said minimum sensor load, is calculated to determine the loading case for the bearing.

3. The roller bearing assembly according to claim 1 where said sensing device includes at least three strain sensors.

4. The roller bearing assembly according to claim 1 where said sensing device includes a substantially axis symmetric flexing member.

5. The roller bearing assembly according to claim 1 where said sensing device is contained within an annular outer shell, said outer shell operatively coupled to said outer race.

6. The roller bearing assembly according to claim 1 where said sensing device includes at least three pressure sensors capable of sensing pressure within a material trapped in an annular cavity between said rib ring and said pressure sensors, said sensed pressure representative of roller forces on said rib ring.

7. The roller bearing assembly according to claim 1 where said sensing device includes at least three compressive load sensors capable of sensing an applied load from said rib ring, said sensed load representative of roller forces on said rib ring.

8. The roller bearing assembly according to claim 1 wherein said load is a compressive load..

9. The roller bearing assembly according to claim 1 wherein said load is a tensile load.

10. An improved roller bearing assembly having an annular outer race surrounding an annular inner race, a set of tapered rollers contained within a radial gap between the outer and inner races, a rib ring contacting an outer end of the rollers to contain the rollers within the radial gap, and an annular outer shell coupled to the outer race, said tapered rollers transmitting both axial and radial forces between said inner race and said outer race; the improvement comprising:
a set of at least three spaced-apart sensors operatively disposed in annular proximity to said rib ring within the outer shell, said set of sensors generating at least one output signal representative of the axial and radial forces exerted on said rib ring by the set of rollers.

11. The improved roller bearing assembly of claim 10 wherein said set of sensors includes a plurality of compressive load sensors disposed in an equidistant annular configuration;
wherein said rib ring includes a plurality of axial protrusions, each of said axial protrusions aligned with, and in contact with one of said compressive load sensors; and
wherein forces exerted on said rib ring by said set of rollers are conveyed to said compressive load sensors through said axial protrusions.

12. The improved roller bearing assembly of claim 11 wherein said plurality of compressive load sensors are each disposed over gaps in an annular support member abutting said outer shell; and
wherein said plurality of axial protrusions are aligned with said gaps in said annular support member.

13. The improved roller bearing assembly of claim 10 further including a first set of equidistantly spaced axial protrusions on said rib ring, and a second set of equidistantly spaced axial protrusions on an inner surface of said outer shell, said first and second sets of axial protrusions annularly offset from each other;
a flexing element disposed between said first and second set of axial protrusions;
wherein said set of sensors includes a plurality of strain sensors disposed in an annular configuration on said flexing element, each of said strain sensors configured to generate an output signal representative of a localized strain in said flexing element responsive to a load on said rib ring from the set of rollers.

14. The improved roller bearing assembly of claim 10 wherein said rib ring includes a disk portion and a cylindrical portion, a peripheral end of said disk portion abutting a portion of said outer shell, and a surface of said cylindrical portion adjacent a portion of said outer shell set, whereby said outer shell and said rib ring define an annular cavity;
a substantially incompressible material disposed within said annular cavity; and
at least three pressure sensors disposed on an annular support member within said annular cavity wherein forces exerted on said rib ring by said set of rollers are conveyed to said pressure sensors through said incompressible material.

15. The improved roller bearing assembly of claim 14 wherein said substantially incompressible material is a room temperature vulcanizing material.

16. The improved roller bearing assembly of claim 14 wherein said substantially incompressible material resists circumferential flow.

17. The improved roller bearing assembly of claim 14 wherein at least one of said pressure sensors is disposed an proximity to an annular point of maximum load about said rib ring.

18. The improved roller bearing assembly of claim 10 wherein said force is a compressive force.

19. The roller bearing assembly of claim 10 wherein said force is a tension force.
